(19) United States
(12) Patent Application Publication
(10) Pub. No.: US 2024/0202041 A1
(43) Pub. Date: Jun. 20, 2024

(54) METHOD, APPARATUS AND SYSTEM FOR AUTOMATICALLY SCALING DYNAMIC COMPUTING RESOURCES BASED ON PREDICTED TRAFFIC PATTERNS

(71) Applicant: FOUNDATION OF SOONGSIL UNIVERSITY-INDUSTRY COOPERATION, Seoul (KR)

(72) Inventors: Young Han KIM, Seoul (KR); Tae Hoon KIM, Seoul (KR)

(73) Assignee: FOUNDATION OF SOONGSIL UNIVERSITY-INDUSTRY COOPERATION, Seoul (KR)

(21) Appl. No.: 18/515,576

(22) Filed: Nov. 21, 2023

(30) Foreign Application Priority Data
Dec. 19, 2022 (KR) 10-2022-0178013
Apr. 14, 2023 (KR) 10-2023-0049211

(51) Int. Cl. G06F 9/50

(52) U.S. Cl. CPC G06F 9/505; G06F 9/5072

(57) ABSTRACT

An apparatus, method, and system for automatically scaling dynamic computing resources based on predicted traffic patterns are disclosed. A system for automatically scaling dynamic computing resource based on a predicted traffic pattern comprises a prediction API for predicting resource according to a traffic request for each cluster configured on a workload server using a pre-trained machine learning model; and a prediction-based autoscaler for calculating required resource by comparing available resource for each cluster with the predicted resource, selecting an optimal flavor according to the calculated required resource, and generating a template corresponding to the selected optimal flavor.

### CROSS-REFERENCE TO RELATED APPLICATIONS

This application claims the benefit of Korean Application Nos. 10-2022-0178013 filed Dec. 19, 2022, and 10-2023-0049211 filed Apr. 14, 2023, in the Korean Intellectual Property Office. All disclosures of the documents named above are incorporated herein by reference.

### TECHNICAL FIELD

The present invention relates to a method, apparatus, and system for automatically scaling dynamic computing resources based on predicted traffic patterns.

### BACKGROUND ART

Kubernetes is an open-source platform for managing containerized services and workloads and is being actively used by many companies as they transition their systems to a cloud environment.

Kubernetes operates on a cluster basis, which is a set of worker nodes that host container-type applications and master nodes that manage the worker nodes. By operating multiple clusters together, the multi-cluster infrastructure has the advantages of improving application availability and reducing user waiting time.

Recently, integrated management functions have become important in a hybrid cloud-based multiple Kubernetes cluster environment that simultaneously operates private clouds and public clouds.

To this end, one of a variety of cluster management programs can be installed to receive integrated node management functions to simplify operations, such as generating and upgrading Kubernetes clusters in a hybrid cloud environment and adding automatic recovery policies. Additionally, various autoscaling programs used for autoscaling of worker nodes can be linked with the programs mentioned above.

However, most autoscaling algorithms have limitations.

First, it generates worker nodes when pods can no longer be scheduled due to a lack of resources, which can cause downtime issues.

Second, the method is to secure available resources in advance by applying PriorityClass to the overprovisioning pod containing the pause container and setting the priority to low. In order to respond to sudden traffic, overprovisioning pods are operated to occupy about 20% of total system resources, so each time a new node is generated, the number of replicas of overprovisioning pods can also increase, which has the disadvantage of occupying unnecessary resources. Lastly, because scaling is based on a fixed template provided by the cluster management program, it is difficult to respond flexibly to various situations.

### DISCLOSURE

### Technical Problem

In order to solve the problems of the prior art described above, the present invention proposes a method, apparatus, and system for automatically scaling dynamic computing resources based on predicted traffic patterns that can minimize unnecessary resource occupation and flexibly cope with various situations.

### Technical Solution

In order to achieve the above object, according to an embodiment of the present invention, a system for automatically scaling dynamic computing resource based on a predicted traffic pattern comprises a prediction API for predicting resource according to a traffic request for each cluster configured on a workload server using a pre-trained machine learning model; and a prediction-based autoscaler for calculating required resource by comparing available resource for each cluster with the predicted resource, selecting an optimal flavor according to the calculated required resource, and generating a template corresponding to the selected optimal flavor.

The pre-trained machine learning model may be a Bi-LSTM model based on a recurrent neural network.

The traffic request and the available resource may be received by calling a monitoring system, and the monitoring system may monitor traffic requests flowing into the workload server by segmenting them for each cluster.

Information on a collected traffic request may be transmitted to a traffic mesh when a trigger point is activated in the monitoring system and a resource utilization rate of a given cluster is greater than or equal to a preset value.

The trigger point is SNMP_exporter, and the SNMP_exporter is initially in an off state, and when the resource utilization rate is greater than or equal to a preset first threshold, the SNMP_exporter may be changed to an on state and the information on the traffic request may be stored in a database of the monitoring system.

If the resource utilization rate is greater than or equal to a second threshold greater than the first threshold, the information on the traffic request stored in the database may be transmitted to a storage for training the machine learning model.

The template may be compatible with a currently operating cluster management program.

According to another aspect of the present invention, an apparatus for automatically scaling dynamic computing resource based on a predicted traffic pattern comprises a processor; and a memory connected to the processor, wherein the memory stores program instructions for performing operations comprising predicting resource according to a traffic request for each cluster configured on a workload server using a pre-trained machine learning model, and calculating required resource by comparing available resource for each cluster with the predicted resource, selecting an optimal flavor according to the calculated required resource, and generating a template corresponding to the selected optimal flavor.

According to another aspect of the present invention, a method for automatically scaling dynamic computing resource based on a predicted traffic pattern in an apparatus including a processor and a memory comprises predicting resource according to a traffic request for each cluster configured on a workload server using a pre-trained machine learning model; calculating required resource by comparing available resource for each cluster with the predicted resource; selecting an optimal flavor according to the calculated required resource; and generating a template corresponding to the selected optimal flavor.

According to another aspect of the present invention, a computer program stored in a computer-readable recording medium for performing the above method is provided.

### Advantageous Effects

According to the present invention, it has an advantageous effect in that the idea of turning SNMP_exporter on/off is applied to the monitoring system to minimize storage waste, and the trigger mesh open source is used to efficiently classify valid data and simplify the process of storing it in a machine learning storage.

In addition, according to the present invention, there is an advantage of complementing the limitations of the prior art by predicting the future situation through a machine learning model and a custom module obtained from the corresponding data, determining the flavor, and scaling the worker nodes of the cluster in advance.

### BRIEF DESCRIPTION OF DRAWINGS

These and/or other aspects will become apparent and more readily appreciated from the following description of the embodiments, taken in conjunction with the accompanying drawings in which:

FIG. 1 is a diagram showing the structure of a system for automatically scaling dynamic computing resources based on predicted traffic patterns according to a preferred embodiment of the present invention;

FIG. 2 is a flowchart of a process for automatically scaling dynamic computing resources based on predicted traffic patterns according to this embodiment;

FIG. 3 is a diagram illustrating in detail the process of transmitting information on a traffic request according to this embodiment;

FIG. 4 is a diagram showing the mapping relationship between traffic request amount and resource usage according to the present embodiment; and

FIG. 5 shows the process of comparing the prediction value received from the prediction API and the resource value currently in use to select the optimal flavor in the prediction-based autoscaler module.

### DETAILED DESCRIPTION OF EMBODIMENTS

Since the present invention can make various changes and have various embodiments, specific embodiments will be illustrated in the drawings and described in detail in the detailed description. However, this is not intended to limit the present invention to specific embodiments, and should be understood to include all changes, equivalents, and substitutes included in the spirit and technical scope of the present invention.

The terms used herein are only used to describe specific embodiments and are not intended to limit the invention. Singular expressions include plural expressions unless the context clearly dictates otherwise. In this specification, terms such as “comprise” or “have” are intended to indicate the presence of features, numbers, steps, operations, components, parts, or combinations thereof described in the specification, but are not intended to exclude in advance the possibility of the existence or addition of one or more other features, numbers, steps, operations, components, parts, or combinations thereof.

In addition, the components of the embodiments described with reference to each drawing are not limited to the corresponding embodiments, and may be implemented to be included in other embodiments within the scope of maintaining the technical spirit of the present invention, and a plurality of embodiments may be re-implemented as a single integrated embodiment even if separate descriptions are omitted.

In addition, when describing with reference to the accompanying drawings, identical or related reference numerals will be assigned to identical components regardless of the reference numerals, and overlapping descriptions thereof will be omitted. In describing the present invention, if it is determined that a detailed description of related known technologies may unnecessarily obscure the gist of the present invention, the detailed description will be omitted.

The present invention proposes a method to complement the shortcomings of the prior art using a machine learning-based network traffic prediction system and custom module.

According to this embodiment, traffic requests flowing into the workload server are monitored by segmenting them for each cluster and used as data for training machine learning model for traffic prediction.

At this time, rather than using all traffic as training data, more reliable data can be accumulated by designing it to accumulate only at specific trigger points.

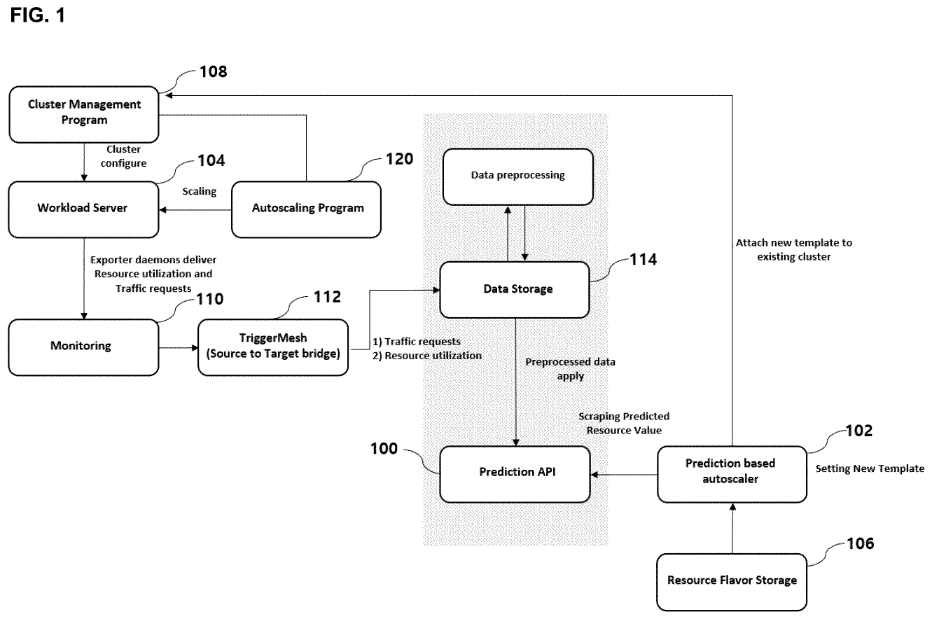

FIG. 1 is a diagram showing the structure of a system for automatically scaling dynamic computing resources based on predicted traffic patterns according to a preferred embodiment of the present invention.

As shown in FIG. 1, the system according to the present embodiment may comprise a prediction API 100 and a prediction-based autoscaler 102.

The prediction API 100 predicts resources according to traffic requests for each cluster configured in the workload server 104 using a pre-trained machine learning model.

The prediction-based autoscaler 102 calculates required resources by comparing available resources for each cluster with predicted resources, selects the optimal flavor according to the required resources, and generates a template corresponding to the selected optimal flavor.

Here, the required resource may be a resource for accommodating traffic requests that exceed available resources.

Here, the flavor is a preset configuration that defines the compute, memory, and storage capacity of the instance, and the prediction-based autoscaler 102 refers to the resource flavor storage 104 to select the optimal flavor.

A template refers to a specification for generating a pod.

The template according to the present embodiment is compatible with the currently operating cluster management program 106.

The machine learning model according to the present embodiment may be a Bi-LSTM model based on a recurrent neural network, and as the amount of training data increases, model accuracy is maximized, and the prediction-based autoscaler 102 may select the optimal flavor through the available resources predicted through the corresponding machine learning model, and then predict the virtual machine (VM) and expand it.

Previously, VMs were expanded only with fixed flavor values in the autoscaling program using templates provided by the cluster management program.

In contrast, in the system according to this embodiment, the prediction-based autoscaler 102 may use the prediction resources of the machine learning-based prediction API 100 to select the optimal flavor value, and generate a new template compatible with the cluster management program 108 in operation and apply it.

According to the present embodiment, the autoscaling program 120 applies the newly generated template to the existing cluster managed by the cluster management program 108.

According to this embodiment, the downtime problem can be solved because the VM is generated in advance, and the operating cost can be minimized because there is no reason to use the overprovisioning method and the VM size is determined and confirmed through resource prediction according to traffic requests, and real-time situations can be flexibly responded.

The prediction API 100 and prediction-based autoscaler 102 call the monitoring system 110 to receive the traffic requests and available resources.

Here, the monitoring system 110 may be a Prometheus server, and the monitoring system 110 monitors traffic requests flowing into the workload server 104 by segmenting them for each cluster.

Information on traffic requests collected by the monitoring system 110 is used to train a machine learning model, but information on traffic requests is accumulated only at specific trigger points.

In the monitoring system 110 according to the present embodiment, a trigger point operates, and when the resource utilization rate of a certain cluster is greater than or equal to a preset value, information on the collected traffic requests is transmitted to the traffic mesh 112.

Here, the trigger point is SNMP_exporter, and the SNMP_exporter is initially in an off state, and when the resource utilization rate is greater than or equal to a preset first threshold, it is changed to an on state and information on traffic requests is stored in the database of the monitoring system 110.

If the resource utilization rate is greater than or equal to the second threshold greater than the first threshold, the information on the traffic request stored in the database is transmitted to the storage 114 for training the machine learning model.

The operation of the above-mentioned trigger point will be described in detail again below.

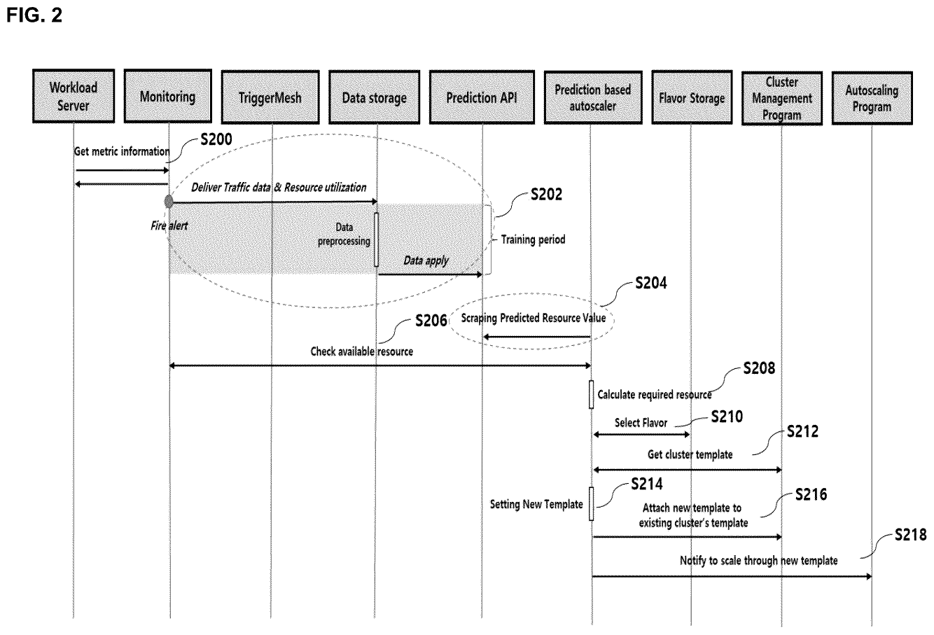

FIG. 2 is a flowchart of a process for automatically scaling dynamic computing resources based on predicted traffic patterns according to the present embodiment.

FIG. 2 shows the process of adding VMs by monitoring the resource utilization rate of the cluster and requested traffic data from the workload server and selecting the optimal flavor based on the corresponding metric values.

Referring to FIG. 2, metric information is exchanged between the workload server 104 and the monitoring system 110 (step 200).

Before calculating the traffic prediction value in the prediction API 100 according to this embodiment, a machine learning model training process is performed (step 202).

In step 202, information on traffic requests collected by the monitoring system 110 is delivered to the storage 114 for training the machine learning model through the traffic mesh 112 in consideration of the resource utilization rate of a given cluster.

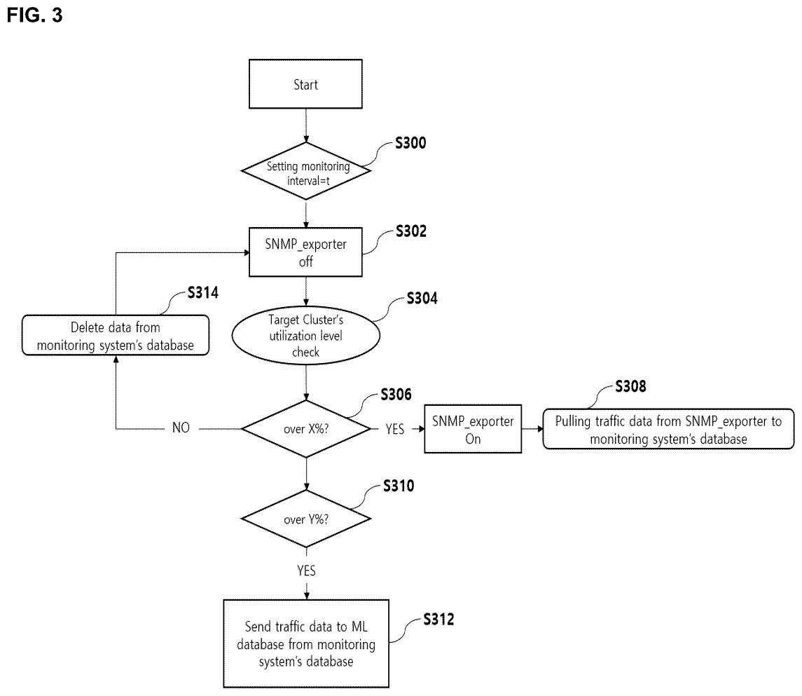

FIG. 3 is a diagram illustrating in detail the process of transmitting information on a traffic request according to the present embodiment.

FIG. 3 may be a process performed in the monitoring system 110 according to this embodiment.

Referring to FIG. 3, first, the monitoring interval is set to t (step 300).

As an initial setting, SNMP_exporter is in an off state when a traffic request flows into the cluster (step 302).

Because the SNMP_exporter is initially in the off-state, the traffic mesh 112 does not receive information on traffic requests from the monitoring system 110.

The monitoring system 110 checks the resource utilization rate of the cluster (step 304) and determines whether the resource utilization rate is greater than or equal to a first preset threshold (e.g., 60%) (step 306).

If the resource utilization rate is greater than or equal to the first threshold, the SNMP_exporter causes information on the traffic request to be stored in a streaming manner in the database of the monitoring system 110 (step 308).

Then, it is determined whether the resource utilization rate is greater than or equal to a second threshold (e.g., 80%) greater than the first threshold (step 310).

If the resource utilization rate is greater than or equal to the second threshold, information on traffic requests stored in the database of the monitoring system 110 is transmitted to the storage 114 for training the machine learning model through the traffic mesh 112 (step 312).

Meanwhile, in step 306, if the resource utilization rate of the cluster is greater than or equal to the first threshold and becomes less than the first threshold after a predetermined time has elapsed, the information on the traffic request stored in the database of the monitoring system 110 is deleted (step 314).

The reason for this deletion is that the data used to train the machine learning model should reflect the latest state. Therefore, when the resource utilization rate of the cluster falls below the first threshold, the corresponding data is deleted from the database of the monitoring system 110, and new data is added to allow the machine learning model to be trained.

If the SNMP exporter is always in an on state, information on all traffic requests is stored in the storage 114 and storage space may be wasted. Therefore, operating cost optimization is possible when information on traffic requests is transmitted as shown in FIG. 3.

According to the present embodiment, when the resource utilization rate is 60% or more and less than 80%, information on traffic requests is only stored but is not transmitted to the storage 114 for training the machine learning model. And when the resource utilization rate is 80% or more, information on traffic requests stored up to that point is transmitted to the storage 114 for training the machine learning model. Information on traffic requests in the 60% to 80% resource utilization rate section is more complex than that in the section below 60%, and since it is about 80% of the resource utilization rate at the time when node scaling is necessary, various patterns in that section can be learned to improve the accuracy of the machine learning model.

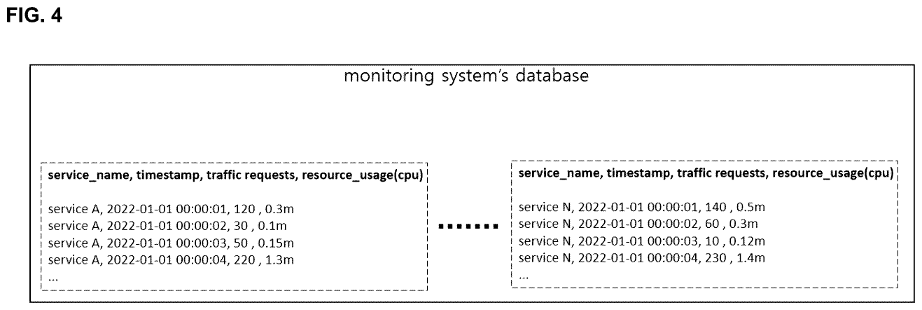

FIG. 4 is a diagram showing the mapping relationship between traffic request amount and resource usage according to the present embodiment.

In FIG. 4, scraping interval and resource usage are defined as follows.
1) scraping interval=1 sec
2) resource_usage (cpu)=abs (previous target cluster's cpu utilization−current target cluster's cpu utilization)

Referring to FIG. 4, data for training a machine learning model is transmitted to the storage 114 for machine learning in the form of a csv file, and then the data is preprocessed, learned in the prediction API 100, and then resource usage according to traffic requests is predicted.

After the training of the machine learning model is completed, prediction resource values are periodically scraped from the prediction-based autoscaler 102 to the prediction API 100 (step 204).

In step 204, the prediction API 100 predicts resources according to traffic requests for each cluster configured in the workload server using a pre-trained machine learning model.

The prediction-based autoscaler 102 calls the monitoring system 110 to receive available resources (step 206), and compares the available resources for each cluster with the predicted resources to calculate the required resources (step 208).

In addition, the prediction-based autoscaler 102 refers to the flavor storage 106 to select the optimal flavor according to the required resources (step 210), obtains a template for each cluster from the cluster management program 108 (step 212), and generates a template corresponding to the selected optimal flavor (step 214).

The prediction-based autoscaler 102 replaces the cluster's template with a newly generated template (step 216) and causes the autoscaling program 120 to perform autoscaling with the new template (step 218).

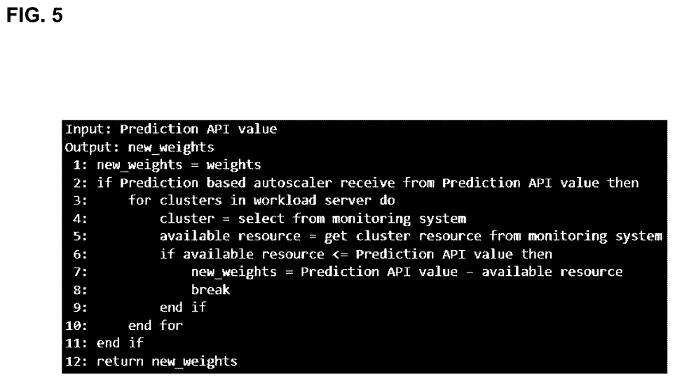

FIG. 5 shows the process of comparing the prediction value received from the prediction API and the resource value currently in use to select the optimal flavor in the prediction-based autoscaler module. The new_weights value obtained through this process can be linked to flavor storage to select an appropriate flavor.

The method for automatically scaling dynamic computer resources based on predicted traffic patterns according to the present embodiment can also be implemented in the form of a recording medium containing instructions executable by a computer, such as an application or program module executed by a computer. A computer-readable medium can be any available medium that can be accessed by a computer and includes both volatile and non-volatile medium, removable and non-removable medium. Additionally, a computer-readable medium may include a computer storage medium. A computer storage medium includes both volatile and non-volatile, removable and non-removable medium implemented in any method or technology for storage of information such as computer-readable instructions, data structures, program modules, or other data.

The method for automatically scaling dynamic computer resources based on predicted traffic patterns described above may be executed by an application installed by default on the terminal (this may include programs included in the platform or operating system installed by default on the terminal), and may also be executed by an application (i.e., program) installed directly on the master terminal by a user through an application providing server such as an application store server, or a web server related to the application or the service. In this sense, the method for automatically scaling dynamic computer resources based on predicted traffic patterns described above can be implemented as an application (i.e., program) installed by default in the terminal or directly installed by the user and recorded on a computer-readable recording medium.

The above-described embodiments of the present invention have been disclosed for illustrative purposes, and those skilled in the art will be able to make various modifications, changes, and additions within the spirit and scope of the present invention, and such modifications, changes, and additions should be regarded as falling within the scope of the patent claims below.

1. A system for automatically scaling dynamic computing resource based on a predicted traffic pattern comprising:
a prediction API for predicting resource according to a traffic request for each cluster configured on a workload server using a pre-trained machine learning model; and
a prediction-based autoscaler for calculating required resource by comparing available resource for each cluster with the predicted resource, selecting an optimal flavor according to the calculated required resource, and generating a template corresponding to the selected optimal flavor.

2. The system of claim 1, wherein the pre-trained machine learning model is a Bi-LSTM model based on a recurrent neural network.

3. The system of claim 1, wherein the traffic request and the available resource are received by calling a monitoring system,
wherein the monitoring system monitors traffic requests flowing into the workload server by segmenting them for each cluster.

4. The system of claim 3, wherein information on a collected traffic request is transmitted to a traffic mesh when a trigger point is activated in the monitoring system and a resource utilization rate of a given cluster is greater than or equal to a preset value.

5. The system of claim 4, wherein the trigger point is SNMP_exporter,
wherein the SNMP_exporter is initially in an off state, and when the resource utilization rate is greater than or equal to a preset first threshold, the SNMP_exporter is changed to an on state and the information on the traffic request is stored in a database of the monitoring system.

6. The system of claim 5, wherein if the resource utilization rate is greater than or equal to a second threshold greater than the first threshold, the information on the traffic request stored in the database is transmitted to a storage for training the machine learning model.

7. The system of claim 1, wherein the template is compatible with a currently operating cluster management program.

8. An apparatus for automatically scaling dynamic computing resource based on a predicted traffic pattern comprising:
a processor; and
a memory connected to the processor,
wherein the memory stores program instructions for performing operations comprising,
predicting resource according to a traffic request for each cluster configured on a workload server using a pre-trained machine learning model,
calculating required resource by comparing available resource for each cluster with the predicted resource,
selecting an optimal flavor according to the calculated required resource, and
generating a template corresponding to the selected optimal flavor.

9. A method for automatically scaling dynamic computing resource based on a predicted traffic pattern in an apparatus including a processor and a memory comprising:
predicting resource according to a traffic request for each cluster configured on a workload server using a pre-trained machine learning model;
calculating required resource by comparing available resource for each cluster with the predicted resource;
selecting an optimal flavor according to the calculated required resource; and
generating a template corresponding to the selected optimal flavor.

10. The method of claim 9, wherein the pre-trained machine learning model is a Bi-LSTM model based on a recurrent neural network.

11. The method of claim 9, wherein the traffic request and the available resource are received by calling a monitoring system,
wherein the monitoring system monitors traffic requests flowing into the workload server by segmenting them for each cluster.

12. The method of claim 11, wherein information on a collected traffic request is transmitted to a traffic mesh when a trigger point is activated in the monitoring system and a resource utilization rate of a given cluster is greater than or equal to a preset value.

13. The method of claim 12, wherein the trigger point is SNMP_exporter,
wherein the SNMP_exporter is initially in an off state, and when the resource utilization rate is greater than or equal to a preset first threshold, the SNMP_exporter is changed to an on state and the information on the traffic request is stored in a database of the monitoring system.

14. The method of claim 13, wherein if the resource utilization rate is greater than or equal to a second threshold greater than the first threshold, the information on the traffic request stored in the database is transmitted to a storage for training the machine learning model.

15. A computer program stored in a computer-readable recording medium for performing the method of claim 9.
